(19) United States
(12) Patent Application Publication
(10) Pub. No.: US 2013/0235400 A1
(43) Pub. Date: Sep. 12, 2013

(54) SYSTEMS AND METHODS FOR PRESENTING ORIENTATION FLOW GRAPHS IN THREE DIMENSIONS IN COMPLEX DOCUMENT HANDLING AND IMAGE FORMING DEVICES

(71) Applicant: Paul Roberts CONLON, South Bristol, NY (US)

(72) Inventor: Paul Roberts CONLON, South Bristol, NY (US)

(73) Assignee: XEROX CORPORATION, Norwalk, CT (US)

(21) Appl. No.: 13/417,136

(22) Filed: Mar. 9, 2012

(51) Int. Cl. G06K 15/16

(52) U.S. Cl. 358/1.12

(57) ABSTRACT

A system and method are provided for automatically defining composite orthogonal orientation transformation matrices for operations along multiple processing paths in document handling and image forming systems using orientation flow graphs in three dimensions. Individual nodes between operations or component devices in the system are identified. Individual operations that occur in the component devices between the identified individual nodes are described. Mathematical representations associated with each of the individual operations are specified. For a given path, the mathematical representations associated with each of the individual operations along that path, between each pair of nodes, are matrix multiplied to render a composite transformation matrix that represents an overall change in an orthogonal orientation along each of the individual processing paths. An inverse of the composite transformation matrix is applied to a mathematical representation of an output orthogonal orientation to define pre-flight conditions for image receiving media.

This application is related to U.S. Patent Application Publication Nos. 2010/0156890, filed Dec. 18, 2008; 2010/0157325, filed Dec. 11, 2009; 2010/0158411, filed Dec. 18, 2008; 2010/0157324, filed Dec. 11, 2009; 2010/0156937, filed Dec. 18, 2008; 2010/0157323, filed Dec. 11, 2009; 2010/0156940, filed Dec. 19, 2008; 2010/0156938, filed Dec. 11, 2009; 2010/0157319, filed Dec. 11, 2009; 2010/0157320, filed Dec. 11, 2009; 2010/0157322, filed Dec. 11, 2009; and 2010/0157321, filed Dec. 11, 2009, each of which is entitled “Method And System For Utilizing Transformation Matrices To Process Rasterized Image Data.” This application is also related to U.S. Patent Application Publication Nos. 2011/0109918, filed Nov. 9, 2009, entitled “Controlling Placement And Minimizing Distortion Of Images In An Imaging Device,” and 2011/0109919, filed Nov. 9, 2009, entitled “Architecture For Controlling Placement And Minimizing Distortion Of Images,” and U.S. patent application Ser. Nos. 13/155,756, filed Jun. 8, 2011, entitled “Frame-Based Coordinate Space Transformations Of Graphical Image Data In An Image Processing System,” and 13/155,723, filed Jun. 8, 2011, entitled “Image Operations Using Frame-Based Coordinate Space Transformations Of Image Data In A Digital Imaging System” and [Attorney Docket No. 056-0469], entitled “Systems And Methods For Employing Declarative Programming To Optimize Dynamic Operations In Complex Image Forming And Media Handling Devices.” These applications are co-owned by the Assignee of this application. The disclosures of the related applications are hereby incorporated by reference herein in their entirety.

### BACKGROUND

1. Field of Disclosed Subject Matter

This disclosure relates to systems and methods for automatically defining composite orthogonal orientation transformations for operations along multiple processing paths in complex document handling and image forming systems using orientation flow graphs.

2. Related Art

Complex document handling and image forming systems combine image forming processes and associated media handling and finishing processes. In the field of image forming devices, very complex production-type systems for advanced image forming, and the associated media handling, have been, and continue to be, developed and deployed. These complex document handling and image forming systems may include, for example, multiple stages of image processors with a plurality of feeder devices and a number of finishing devices. Image receiving media flow through these complex image forming (and media handling) systems via multiple paths in an intricate and variable manner according to a particular image forming operation requested by a user and carried out by the complex document handling and image forming system.

An ordering of the multiple devices in these complex image forming systems can be changed. Individual devices are reordered or replaced in a particular complex document handling and image forming system for myriad reasons. As a result, imaging and image receiving media flow paths through the complex document handling and image forming systems can be changed and can often become confused. In many instances, a result of this confusion is that image forming errors and/or finishing errors occur. Images can be printed upside down, on a wrong side of the paper, or not in a pre-printed form as a user intended. When a pre-printed form is loaded incorrectly, the overlaying image is oriented incorrectly. This can be corrected in a number of ways. The loading of the pre-printed form could be changed to a certain orientation in three dimensions. Otherwise, the complex document handling and image forming system may be made to comprehend the orientation “error” and, for example, rotate the image independently to match the orientation of the pre-printed form. One modifies the orientation of the image receiving medium, while the other modifies image orientation. Finishing errors may include staples being placed in the wrong corner or folds being improperly applied. Image shifts can be performed in a manner that is wholly detached from an anticipated orientation of the image receiving medium resulting in an improper image shift. These errors, individually or collectively, produce outputs from the complex document handling and image forming systems that are not the finished product that the user expects, leading to customer dissatisfaction.

What is not clear to the common user of the complex document handling and image forming system, but is common knowledge to those of skill in the art, is that any particular imaging task or job requested by a user includes multiple individual imaging operations each according to specified orthogonal orientations. An exemplary and non-exhaustive list of individual imaging operations includes scaling or sizing, translation or image shift, mirroring or reflecting, and rotation of images in two dimensions and of image receiving media in three dimensions. Each individual image processing and/or media handling component that is included as a portion of a particular complex document handling and imaging forming system may carry out individual tasks with a particular flow of the images and the image receiving media through that individual component.

Difficulties often arise in that an order of individual image forming operations is non-commutative. As such, certain manipulation of the order of the operations, including adding additional steps, is often undertaken to produce a repeatable output based on an ordering of the operations. This manipulation can make the outcome of the operations repeatable. Stated differently, any change in the order of these operations as a set of transformations will typically result in a different output unless modified in some manner that may or may not be available to the system designer and/or programmer. An additional difficulty is that individual orientations of images and image receiving media at any particular point in the image forming process in the complex image forming system are difficult to track externally.

The above difficulties can be compounded based on conventional approaches to programming of the individual component devices and specifically characterizing orientations of images and image receiving media within that programming. The characterizations of orientations of images and image receiving media in the programming of conventional document handling and image forming systems are generally viewed, and therefore provided, in a descriptive or narrative form. When programs are written in, for example, C code or C++, rather than characterizing the image orientations according to any common and manipulable mathematical framework, descriptive terms (or enumerations) are employed. These may include, for example, descriptors such as “faceup” or “facedown,” and “inboard” or “outboard.” With regard to raster orientations, similar descriptive terms are used such as, for example, “slow scan” and “fast scan.” These descriptive terms may be generally understood and tracked in the context of a single simple image forming device. Interpretation of these descriptive terms, however, across different devices tends to be inconsistent and therefore haphazard. The inconsistencies manifest themselves in two general ways.

First, the descriptive terms are often not consistent across devices and manufacturers as variations in the descriptive terms may be employed by individual manufacturers, or applied to individual devices leading to difficulties in interpretation between different devices. In other words, different words may be used to describe the same or similar operations, thereby leading to interpretational difficulties.

Second, even if consistent descriptive terms are used, the points of origin for the operations and directions in which the operations are undertaken (orthogonal orientations) may differ between devices and between manufacturers. Many times devices or fleets of devices, even when produced by a same manufacturer, use different origin points and/or coordinate references as a basis by which to interpret the descriptive labels for the orientations of images and image receiving media in individual devices. Without a common frame of reference, the descriptive terms are left to the interpretation of the individual devices according to individual device frames of reference as individual devices carry out electronic image scanning and processing functions as well as mechanical image media handling and finishing functions.

Overall imaging operations such as device specific scaling, translation, reflection, rotation and edge erase are individually undertaken relative to a particular coordinate space referenced to a particular origin for a particular device that may be completely different from another coordinate space referenced to another origin for another device even as those devices are combined to form a complex document handling and image forming system. The coordinate spaces and origins by which a particular image forming device or component references image and image receiving media orientations can differ from component device to component device in an overall composite system.

As an example, scanners have varying origins and scanning directions such that saved scanned images may be inconsistent across different scanning devices. Print and Copy/Scan operations suffer similar shortfalls. Scaling, as another example, is conducted relative to a particular origin or reference point and in a particular direction. Across differing devices, a user's request to scale down or scale up (reduce/enlarge) a particular image may result in different image registration or clipping (cropping) regions according to different device origins and orientations, thereby frustrating the user's expectations.

Another commonly understood example is that individual devices rotate and flip images and image receiving media in different directions, clockwise or counter clockwise for planar rotations, and with respect to different corners or edges for image receiving media flipping. In the context of ordered operations, the direction in which an image, or an image receiving medium is rotated, and the edges about which the image receiving medium is flipped, must be specified because rotating an image in an opposite direction, or flipping an image receiving medium about a different edge, will result in different image registration for the image on the image receiving medium.

Origins, directions of execution and orders of particular internal operations are often fixed for each individual image forming device or component and separately for each individual media handling device or component, including those that together make up complex document handling and image forming systems. The user cannot generally select a different origin, i.e., a particular corner, the center, or an arbitrary point in the imaging frame, or a different order of operations for a particular component device. The user cannot generally specify a different direction of rotation, or a different edge about which image media is to be flipped from, for example, a faceup to a facedown orientation, when, for example, a particular image output is not according to a user's desires. Also, it is difficult to even specify both orientations and operations, i.e., rotation and/or reflection because the current approaches are so disconnected. This difficulty is then compounded when one considers that image paths are two-dimensional and image receiving medium paths are three-dimensional. The operations and orientations are disconnected within each of these paths, these disconnects compounding across the image and image media handling domains.

Significant difficulties result from the compounding of all of the above issues. Image receiving media flow through complex document handling and image forming systems according to orientations in three dimensions with the variable image orientations and variable raster device orientations, each according to its own reference and orientation framework, i.e., not according to any common framework. The system designer and/or programmer must piece together individual components of the complex document handling and image forming system, each with its own specified order of operations and origins and orientations, initially according to a complex iterative trial and error process in order to provide a complex document handling and image forming system in which a user obtains an output from his or her requested imaging job according to the user's desires. For example, if a sheet of image receiving media goes through a complex document handling and image forming system, and at the output of the complex system the image is upside down, the system designer and/or programmer may add a rotation to account for this discrepancy. This iterative trial and error process would be further compounded, for example, if in addition to the image being registered upside down on the image receiving medium, the image was also printed on the wrong face of the image receiving medium.

Once this complex iterative trial and error method is completed for a particular complex system, the system designer and/or programmer is not finished. The schemes that result from the trial and error process remain very fragile. Even slight changes in operations can cripple the correctness of the solution. When a particular component in the complex document handling and image forming system is replaced, the process must be repeated, often again in a trial and error manner, in order to obtain a repeatable outcome that is according to the user's desires. In other words, any slight change in configuration for the system generally renders all of a previous trial and error effort to determine a correct scheme a nullity. The system programmer must, in many cases, essentially start over from scratch.

Again, this is because a particular orientation for each of the image and the image receiving medium at any point in the image flow path through the complex system is difficult to envision according to conventional methods.

Add to the above the following factors for consideration. First, sheets of image receiving media can be loaded in an input tray in multiple ways and can be inverted and rotated based on particular system configurations. Second, multiple complex upstream image receiving media feeding devices and downstream finishing devices can impose constraints on orientations of image receiving media in the image receiving media transport paths and orientations of related images during image processing. Post-marking sheet inverters and rotators (90, 180) can be included, if orientations are recognized, to map between the marking device, such as, for example, a printer or multi-function device (MFD) output and a finisher input in order to present the marked image receiving media output from the marking device at a proper orientation to be acted correctly upon by the finisher. The above difficulties, however, conventionally allow for recognition of required orientations only at the output end of the complex document handling and image forming device, leading to the trial and error approach back at the input end to get the orientation correct for each of the multiple paths through the complex system. Sophisticated image receiving media scheduling algorithms often exist within a particular component device, but the information provided by these components to, for example, an overall scheduling algorithm in the complex system lacks required information regarding device-to-device orientations. The many available configurations and interconnections between component devices are difficult to define. Managing orientations of images and image receiving media across an entire end-to-end workflow combining multiple particular component devices is, therefore, challenging and tends to be error prone.

Workflow enablers, such as Job Definition Format (JDF), exist that may limitedly address orientation issues. JDF facilitates cross-vendor workflow implementations. These workflow enablers do not, however, provide a general formal solution to the difficulties in tracking orientations in complex document handling and image forming systems.

### SUMMARY OF THE DISCLOSED EMBODIMENTS

In view of the above-identified shortfalls in conventional complex document handling and image forming systems, previous research by the inventor of the subject matter of this disclosure has defined a common framework for transformation of image origins and coordinate spaces across multiple devices. See, e.g., co-owned U.S. patent application Ser. Nos. 13/155,756, entitled “Frame-Based Coordinate Space Transformations Of Graphical Image Data In An Image Processing System” and 13/155,723, entitled “Image Operations Using Frame-Based Coordinate Space Transformations Of Image Data In A Digital Imaging System.”

In a three-dimensional system, there is a set of forty-eight definable coordinate systems that represent all of the possible orthogonal orientations for image receiving media in an image forming device. (Note that imaging in printing applications typically occurs in a two-dimensional coordinate system. In the two-dimensional system, there is a set of eight definable coordinate systems that may simply be considered a subset of the set of forty-eight definable non-standard three-dimensional coordinate systems in which Z is consistently set to zero. In this manner, two-dimensional imaging operations may interoperate seamlessly with three-dimensional operations performed on image receiving media). One of the forty-eight variations represents the standard Cartesian coordinate system, and the other forty-seven variations are deviations from that standard. For ease of interpretation, and to avoid confusion, this disclosure will refer to the available set of coordinate systems as “the forty-eight coordinate systems.” This set of forty-eight coordinate systems is based on the existence of six permutations of XYZ orientations that can be mapped to each of the eight corners of a cube representing the three-dimensional system. These forty-eight coordinate systems can be alternatively mathematically represented according to a corresponding set of forty-eight individual mathematical representations that respectively identify each of the coordinate systems.

Examples of limited numbers of the above-described mathematical representations and associated visual representations are presented in the above-identified co-owned U.S. patent applications. FIGS. 1A and 1B illustrate an example correspondence between a visual representation of a three-dimensional coordinate system 100 and a corresponding mathematical representation 150 according to this inventor's previous work as a foundation for the disclosed systems and methods. As shown in FIG. 1A, the coordinate system may be visually represented as having an origin 110 from which orthogonal axes, X-axis 120, Y-axis 130 and Z-axis 140 emanate. The origin 110 could be any one of the eight corners of the depicted cube. Varying combinations of the axes will emanate from each of those origins resulting collectively in the forty-eight coordinate systems discussed above. A mathematical representation 150, in a mathematical matrix format as shown in FIG. 1B, may be assigned to each of the forty-eight coordinate systems. The assignment of mathematical representations, in a mathematical matrix format, as shown, facilitates combining program operations (transformations) using matrix algebra as a processing medium for the systems and methods according to this disclosure. It should be noted that the specific mathematical representations shown in FIG. 1B, and in the referenced documents, are only examples of the mathematical representation matrices that could be employed to define each of the forty-eight coordinate systems. Those of skill in the art of image forming systems and mathematics will recognize that a particular three-dimensional coordinate system can be represented in a number of different ways mathematically in the form of a numerical matrix.

Regardless of their construct, the corresponding set of forty-eight individual mathematical representations, when taken together, define a mathematical group. With the forty-eight coordinate systems being defined or represented mathematically, matrix algebra is applied in manipulation of the individual mathematical transformations to rotate or reflect the orthogonal orientations represented by the coordinate systems to different ones of the forty-eight possible orientations. Each resultant orientation is a member of the mathematical group. Any series of multiple operations applied to a beginning orientation necessarily results in an ending orientation that is defined as one of the orientations in the group.

An advantage of finding a common definition or interpretation for the multiple coordinate systems, as they are applied to complex document handling and image forming systems is that individual orientations of images and image receiving media in the complex system can be succinctly expressed and manipulated according to the common mathematical framework. Coordination can then be effected between the image receiving media flowing through the complex system of multiple component devices and images being processed by the complex system according to raster images and visual images. Application of the mathematical framework provides a capability by which the effects of changes that are made in an order of imaging operations can be accurately predicted and evaluated, obviating the requirement for conventional complex trial and error processes in order to achieve or maintain the desired output from the complex system. The derived mathematical framework facilitates a level of automation and precision that was previously unavailable to system designers and/or programmers.

The above-referenced prior work of the inventor of the subject matter of this application described image and image receiving media orthogonal orientations using the group of forty-eight coordinate systems (and the related orthogonal orientation matrices) as an abstract concept with potential applicability to many image and image receiving media orientation tracking issues. The solution presented in that previous work was limited to generating the specified set of mathematical representations forming the mathematical group that could then be manipulated using matrix algebra principles to provide an example of a common mathematical framework for interpreting the orthogonal orientations of images and image receiving media in image forming devices in a manner that is device and/or vendor agnostic. With a special centered form, orientation operations of rotation and reflection of images in two dimensions, and image receiving media in three dimensions, may apply associated standard affine graphics operations on the closed mathematical representation group.

It would be advantageous in view of the above-identified shortfalls in orientation tracking to provide a system and method that would combine the new orientation approaches described above with reference to this inventor's previous work with existing algorithmic graphics theory to simplify the description of a flow of orientations along various imaging and image receiving media processing paths in a complex document handling and image forming system.

Exemplary embodiments of the systems and methods according to this disclosure may describe a configuration of orthogonal orientations in a complex document handling and image forming system.

Exemplary embodiments may identify individual interconnections between nodes in the complex system and characterize operations that occur along those interconnections as mathematical representations, in a manner that allows for automated identification of a complex mathematical transformation that occurs across each of multiple processing paths in the complex document handling and image forming system.

Exemplary embodiments may apply the above-described orthogonal orientation definition concepts in a manner that provides a directed graph to represent a graphical “machine model” for a complex document handling and image forming system. The directed graph may be generated from simply specifying an adjacency list for the nodes. Those of skill in the art recognize that a directed graph is a mathematical construct, which may be generated as a visual graph. Adjacency lists are simple to define, and lend themselves well to complex image forming environments in which each device can add just its pairs and/or operations and the system will combine to create a full list that is used for directed graph. In this manner, sophisticated scheduling algorithms may be augmented with fine-grained orientation manipulations to provide a simple, user-friendly graphical depiction of orientation flows in individual device components and across an entire complex document handling and image forming system. The disclosed systems and methods are relatively easily scalable to accommodate large networks of collaborating document handling and image forming devices, with multiple image and image receiving media processing paths, in a manner that prior art manual approaches could never attempt.

Exemplary embodiments provide a mathematically repeatable framework by which individual composite transformations of orthogonal orientations along multiple paths in a complex document handling and image forming system may be defined.

Exemplary embodiments may identify individual nodes along multiple processing paths in the complex document handling and image forming system and specify orthogonal orientation changing operations (transformations) that occur between each adjacent pair of nodes along those paths, and mathematically represent those transformations in order that matrix algebra principles can be applied to arrive at a complex composite orthogonal orientation transformation that occurs along each of the multiple paths in a complex document handling and image forming system.

Exemplary embodiments may apply the automatically-calculated composite transformations to a required or desired output orthogonal orientation for a sheet of an image receiving medium in order to provide to a user a specification of an orthogonal orientation by which the sheet of the image receiving medium should be loaded in an image receiving medium source such as, for example, a paper tray. The method thus may provide the user with information regarding proper pre-flight positioning, according to a required orthogonal orientation, of image receiving media in an image receiving media source for the complex document handling and image forming system in order to ensure a repeatable output for the image receiving medium according to a user's desires. The user is thus provided unprecedented insight into pre-flight restrictions for either of the input images, or conditions (orientations) for the input image receiving media.

Exemplary embodiments may provide an automated system by which, when an individual component device in one or more processing paths in a complex document handling and image forming system is replaced, information provided by that individual component device may be used to update a node-to-node map, and an inter-node operation definition for the one or more processing paths in which the individual component was installed to automatically update a composite mathematical matrix representation of each of the affected processing paths.

Exemplary embodiments may augment conventional scheduling software programs by specifically defining orthogonal orientations at each node in the complex document handling and image forming system. Specifically, the systems and methods according to this disclosure may provide mathematical transformation definitions of orthogonal orientations for individual inter-node operations in order that, applying the principles of matrix multiplication, mathematical solutions defining orthogonal orientations at any point in the system, including at an input end and at an output end, can be undertaken, and the complex interrelationship between an orthogonal orientation at the input end and the output end of the complex document handling and image forming system can be defined.

Exemplary embodiments may obtain a required output orientation and apply to that required output orientation an inverse of the composite transformation that defines the change in orthogonal orientation across a particular processing path to arrive at a specified input orientation for one or more sheets of image receiving media.

Exemplary embodiments may provide a method that is simple to set up and to monitor, and by which to prove correctness. Application of the exemplary methods may provide a capacity to derive composite path operations that are efficient and invertible.

These and other features, and advantages, of the disclosed systems and methods are described in, or apparent from, the following detailed description of various exemplary embodiments.

### BRIEF DESCRIPTION OF THE DRAWINGS

Various exemplary embodiments of the disclosed systems and methods for automatically defining composite orthogonal orientation transformations for operations along multiple processing paths in complex document handling and image forming systems using orientation flow graphs in three dimensions will be described, in detail, with reference to the following drawings, in which:

FIGS. 1A and 1B illustrate an example correspondence between a visual representation of a three-dimensional coordinate system and a corresponding mathematical representation according to this inventor's previous work as a foundation for the disclosed systems and methods;

FIG. 2 illustrates a block diagram of a simple example provided to represent a complex document handling and image forming system in which the systems and methods according to this disclosure may be implemented;

FIG. 3 illustrates a directed graph that characterizes the flow relationships between nodes for the block diagram of the simple example of the complex document handling and image forming system shown in FIG. 2;

FIG. 4 illustrates a block diagram of an exemplary system for automatically defining composite orthogonal orientation transformations for operations along multiple processing paths in complex document handling and image forming systems using orientation flow graphs according to this disclosure; and

FIG. 5 illustrates a flowchart of an exemplary method for automatically defining composite orthogonal orientation transformations for operations along multiple processing paths in complex document handling and image forming systems using orientation flow graphs.

### DETAILED DESCRIPTION OF THE DISCLOSED EMBODIMENTS

The systems and methods for automatically defining composite orthogonal orientation transformations for operations along multiple processing paths in complex document handling and image forming systems using orientation flow graphs in three dimensions according to this disclosure will generally refer to this specific combination of utilities or functions for those systems and methods. Exemplary embodiments described and depicted in this disclosure should not be interpreted as being specifically limited to any particular configuration, any particular set of mathematical representations associated with a set of coordinate spaces (or orthogonal orientations) in two or three dimensions, or any particular programming language or scheme, or as being specifically directed to any particular intended use. Any methodology for controlling complex operations in which acted-on components are subjected to a flow of the individual acted-on components through a complex manufacturing system that includes multiple devices each having its own flow path for the acted-on components through a particular device that may orient the acted-on components in three dimensions is contemplated as being included in this disclosure.

Specific reference to, for example, a complex document handling and image forming system throughout this disclosure should not be considered as being limited to any particular type of image forming device including, for example, any of a printer, a copier or a multi-function device. The phrase “complex document handling and image forming system,” as referenced throughout this disclosure is intended to refer globally to virtually any combination of component devices, any system, or any system of systems that include various capabilities for electronic image processing and/or image receiving media handling, including feeding and finishing, that generally (1) receive an image from an image source and an image receiving medium from an image receiving medium source, (2) register the image on the image receiving medium and (3) finish the image forming process by mechanically manipulating the image receiving medium with some manner of finisher such as, for example, a stapling device, a folding device, a binding device, or other like output finishing device that would be familiar to those of skill in the art. The systems and methods according to this disclosure will be described as being particularly adaptable to use in what are described broadly as “complex” document handling and image forming systems including pluralities of feeder and finisher devices, but the systems and methods according to this disclosure should not be considered as being limited by any particular level of complexity or to any particular combination of image processing and/or media handling component devices.

It is common for image forming device vendors to maintain a general “model of machine” (MOM) within production image forming devices. What often distinguishes complex production-type document handling and image forming systems from familiar office devices is the degree of flexibility resident in the complex production-type systems. This flexibility is available, in part, based on an ability to attach multiple and different image receiving media feeding devices (feeders), and multiple and different document finishing devices (finishers), to multiple and different image processing or marking devices. When each of multiple devices is attached to other component devices as a portion of a complex document handling and image forming system, each of the multiple devices typically communicates information regarding the each of the multiple devices to the other component devices. Device specific information may include a graphic or icon of the particular device. Device information is used within the image processing or marking device to which the other devices are attached, while subsets of the device information are also conveyed upstream to, for example, a Digital Front End (DFE) for the complex document handling and image forming system.

In the disclosed Orientation Flow Graph (OFG) scheme, operations that occur in individual component devices in a complex document handling and image forming system are represented as three-dimensional orthogonal transformations. These operations are defined as occurring between specified nodes in the processing paths in the complex system. Each processing path is fully enumerated as a series of adjacent nodes between which the operations occur. For a given processing path, the mathematical representations of the inter-nodal operations (transformations) are composited via matrix multiplication to produce a Composite Transformation Matrix (CTM) for a particular processing path, or a portion thereof. Since the matrix is invertible, the forward path CTM may be inverted using an ordinary matrix inverse operation. This provides users an opportunity, when a pre-printed form, for example, must end up in a given three-dimensional output orientation, that a mathematical representation of that output orientation can be multiplied by the inverse CTM to determine a required pre-flight orientation for the image receiving medium on which the form is pre-printed. Further, while graphics operations are relatively fast, a composite operation is immediate. Having a set of composite path transformations may allow for faster overarching path determination and/or selection using an abbreviated form that contains the same path information.

The OFG structure is simple to define, and can be created or updated dynamically whenever component devices are attached to, or removed from, the complex system, or when imaging operations in a particular processing path change.

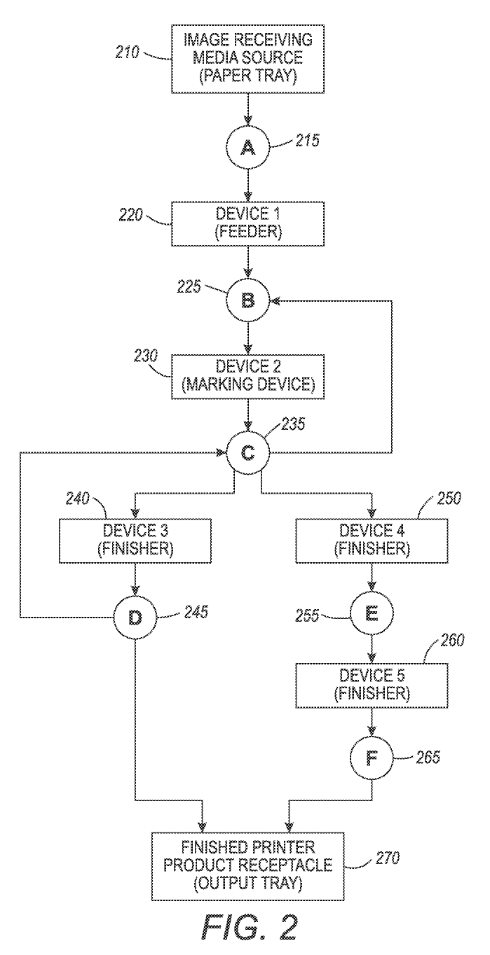

FIG. 2 illustrates a block diagram of a simple example of a complex document handling and image forming system in which the systems and methods according to this disclosure may be implemented. As shown in FIG. 2, between an image receiving media source 210, e.g. a paper tray, and a finished printed product receptacle 270, e.g., an output tray, individual nodes A-F 215, 225, 235, 245, 255, 265 in the complex document handling and image forming system may be specified between individual component devices 220, 230, 240, 250, 260, such as feeders, marking devices and multiple finishers, in one or more of the image processing flow paths for the image receiving media through the complex document handling and image forming system. Individual devices 220, 230, 240, 250, 260, may modify (transform) an orthogonal orientation of the image receiving media such that an orthogonal orientation at each of the individual nodes A-F 215, 225, 235, 245, 255, 265 is different from the orthogonal orientation at a preceding node. For example, a particular device may invert a sheet of image receiving medium about a specified axis of the three axes. (Note that the same concept applies for image manipulation in the complex document handling and performance system, where the Z coordinate is maintained at zero.) Each of these inter-nodal operations may be represented mathematically as a matrix. The transformation in the orthogonal orientation that occurs in each of the individual devices 220, 230, 240, 250, 260, may be thus characterized as a mathematical representation in matrix form for that device between adjacent nodes.

From a block diagram such as that shown in FIG. 2, individual nodes and node adjacencies, by which to generate adjacency lists, can easily be extracted by a system designer, programmer, or user.

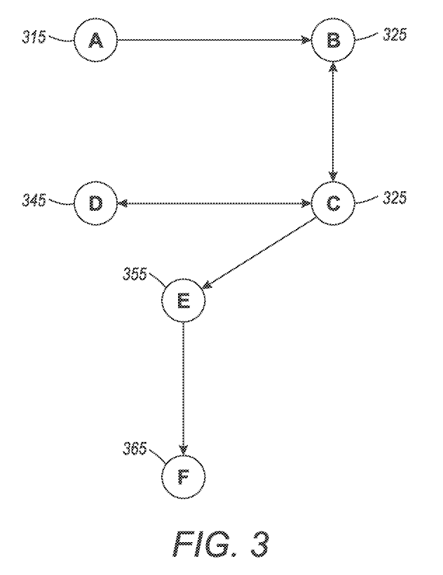

FIG. 3 illustrates a directed graph that characterizes the flow relationships between nodes for the block diagram of the simple example of a complex document handling and image forming system shown in FIG. 2. The exemplary nominal system configuration shown in FIG. 2 may be represented by the disclosed method as a directed graph. Those of skill in the art recognize that the arrows shown in FIG. 3 specify directional relationships between the depicted nodes A-F 315, 325, 335, 345, 355, 365. Nodal connections that include arrows on both ends specify links that include loops.

The method may, therefore, decompose the complex system and may provide a usable depiction as a directed graph. The directed graph may provide an easily-understandable depiction of flow paths between nodes as they relate to system operations for the decomposed complex document handling and image forming system.

As shown in FIG. 3, there are two loops. These loops are, for example, from nodes B to C and back to B, and C to D and back to C. The method is able to decompose the processing paths for the complex document handling and image forming system to include identifying these loops (or cycles). Each of the loops (or cycles) is easily taken into account in defining all of the combinations of node-to-node paths through the complex document handling and image forming system. The method identifies shortest paths, as well as alternative paths including the loops (or cycles), between input node A 315 and either of output nodes D 345 or F 365 to achieve a full complement of path sets. This decomposition is intended to provide a full enumeration of all of the available processing paths through the system including the loops (or cycles). For the simple example shown in FIGS. 2 and 3, a complete listing of the depicted processing paths between an input node A 315 and multiple output nodes D 345 and F 365 may appear as a set as follows:
{{A,B,C,D}, {A,B,C,E,F}, {A,B,C,B,C,D}, {A,B,C,D,C,D}, {A,B,C,B,C,D,C,D}, {A,B,C,B,C,E,F}}

Instead of a user manually attempting to define all of these combinations, or the infinitely more difficult set of combinations associated with even more complex systems, the method may automatically ascertain all of these conditions given a set of input conditions including identifying the nodes and the linear relationships between the nodes according to a directed graph model. It should be easy to appreciate that, in complex document handling and image forming systems, the random variations and permutations in the numbers and complexity of the paths could soon become overwhelming, i.e., a combinatoric explosion.

When additional devices are added, the method perceives the addition of intermediary nodes and is able to dynamically adjust the definition of all of the processing paths through the system according to the inclusion of the additional devices.

Once all of the paths are defined, operations that occur between each of the nodes may be characterized by mathematical representations according to information that may be manually input, or automatically provided to the method via communication with individual component devices along each of the enumerated processing paths.

The method goes through a table of adjacent nodes and identifies the operations along each of the multiple processing paths in order to matrix multiply the mathematical representations of the individual transformations that define the orthogonal orientation changes according to the specific operations along the processing paths between each pair of nodes. The result is a composite transformation matrix for each set of operations along a particular one of the multiple processing paths. Each composite transformation matrix defines the full orthogonal transformation along the given processing path.

A practical application of the above is found in knowing what an output orientation should be and applying an inverse of the derived composite transformation matrix for the particular processing path that will render the output in order to arrive at a mathematical representation of the orthogonal orientation that the image receiving medium should be placed in the input tray in order to ensure that the output orientation is correct.

It should be readily apparent that, because the output orientation can be defined mathematically, and the composite transformation for the orthogonal orientations that occur along a particular path can also be defined mathematically, using these mathematical representations and the principles of matrix algebra, the results are mathematically verifiable. Ambiguity is removed with the ability to mathematically verify the results of the decomposition process. This differs markedly from the conventional trial and error method for determining an overall change in orthogonal orientations across an individual image receiving medium handling path in a complex document handling and image forming system. The user is assured that if a sheet of the image receiving medium is placed in an input tray at an input end of the complex document handling and image forming system, and that sheet of image receiving medium passes through the particularly-defined processing path, the sheet of image receiving medium will be output in a correct and verifiable orientation according to the user's desires.

Individual component devices can inform programs regarding their inherent (and perhaps multiple) individual operations. In other words, individual component devices can be wheeled up and plugged in, and can communicate to the program how their operations affect the orthogonal orientations of the image receiving medium as it passes through that individual component device. Dynamically, when individual devices are plugged in, if one views the input and the output of the individual devices in sequence as constituting nodes in the system, individual devices may communicate with the complex system automatically update the system regarding the transformative operations on orthogonal orientations that are carried out by the individual devices.

All possible paths through a particular system are identified as the method intelligently walks through the complex system and finds all of the ways to get through the complex system for the system designer based only on a definition of nodes and the paths between adjacent pairs of the nodes. Depending on the complexity of the system, it should be recognized that there will be a combinatoric explosion of potential processing paths, all of which are identified by the method in a manner that was previously virtually unachievable using manual mapping methods.

All a user needs to do is to set up a list of individual nodes, and the operations that occur between those nodes. The method then applies, for each of the operations, their individual mathematical representations.

As an easily understood example, consider a situation where a pre-printed form is provided on an image receiving medium in a form to be filled in by the marking device. In the overall complex document handling and image forming system then, the final form is to be stapled in a specified corner, with the staple being in a specified direction through the image receiving medium. Given these constraints, the image receiving medium must be in a specific orientation for the pre-printed form to be correctly filled in, and must be in a separate specific orientation for the stapling to occur correctly. With multiple paths through a complex document handling and image forming system to accomplish these separately assigned tasks according to a user's desires, the disclosed method, given the defined individual node-to-node operations, takes the mathematical representations that are associated with each of those individual operations and matrix multiplies those individual mathematical representations together to obtain a complex transformation that represents an overall change in orientation in three dimensions along each of the multiple processing paths through the complex document handling and image forming system. The output orientation is defined, and the inverse of the mathematical representation of the derived composite transformation is applied to advise the user of the proper pre-flight condition for the image receiving medium to ensure the correct output orientation.

To recap, individual nodes in the complex document handling and image forming system are identified. Individual operations that occur between the identified individual nodes are described. Mathematical representations associated with each of the individual operations are specified. For a given path, the mathematical representations associated with each of the individual operations along that path, i.e., between each pair of adjacent nodes, are matrix multiplied together to render a composite transformation matrix that represents an overall change in orientation in three dimensions along each of the individual processing paths. The ability of the method to fairly easily simplify the process of defining a change in orientation for each path is a significant advantage.

Rather than having to undertake any additional searching, or complex attempts to identify an overall change orientation for a particular processing path, once the above solutions are achieved, for any processing path through the complex document handling and image forming system, e.g., from point A (an input point generally understood as being one or more of an image source an image receiving medium source) to point Z (an output point generally understood to be one or more output receptacles in which image receiving media, with images formed thereon, which are then subject to finishing processing, are deposited), the solved complex transformations provide mathematical representation of what occurs regarding orientations based on the operations (transformations) between those points.

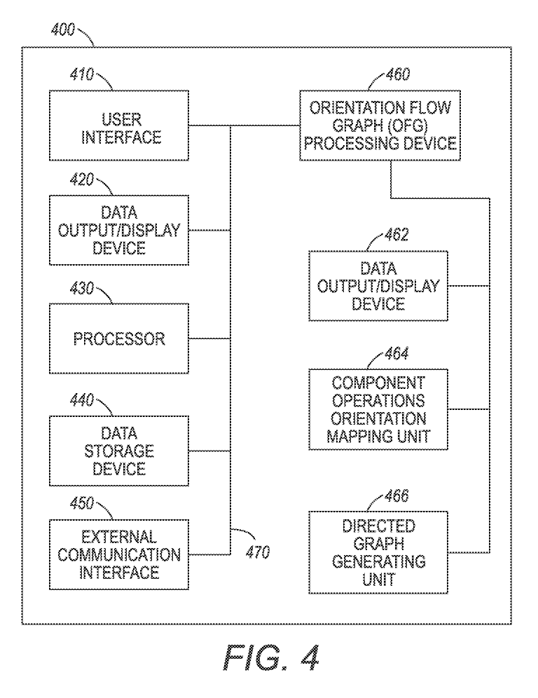

FIG. 4 illustrates a block diagram of an exemplary system 400 for automatically defining composite orthogonal orientation transformations for operations along multiple processing paths in complex document handling and image forming systems using orientation flow graphs according to this disclosure. The exemplary system 400 may be a component of a particular complex document handling and image forming system. Otherwise, the exemplary system 400 may be a standalone system apart from, but in wired or wireless communication with, a particular document handling and/or image forming system. Regardless of the specific constitution, or relationship with any particular document handling or image forming device, the exemplary system 400 may receive information regarding individual component devices that make up a complex document handling and image forming system in order to map multiple flow paths through the complex document forming an image handling system in a manner that will aid system programmers, designers and users in understanding an overall change in orientation of, for example, image receiving media as individual sheets of image receiving media progress along one of the multiple flow paths through the complex document handling an image forming system.

The exemplary system 400 may include a user interface 410 by which a user may communicate with the exemplary system 400. The user interface 410 may be configured as one or more conventional mechanisms common to computing devices such as, for example, a user's workstation that permit the user to input information to the exemplary system 400. The user interface 410 may include, for example, a conventional keyboard and mouse, a touchscreen with “soft” buttons or with various components for use with a compatible stylus, a microphone by which a user may provide oral commands to the exemplary system 400 to be “translated” by a voice recognition program, or other like device by which a user may communicate specific operating instructions to the exemplary system 400.

The user interface 410 may be employed by the user provide a list of nodes between operations (component devices) in a complex document handling and image forming system. Via the user interface 410, the user may also input connections between adjacent pairs of nodes along multiple paths in the complex document handling and image forming system in order that a general processor 430 or and orientation flow graph (OFG) [diagram also incorrect] processing device 460 may formulate a node adjacency list to be acted upon further by the processor 430 or the OFG processing device 460. The user may also input identification of individual component devices that are included in the complex document handling and image forming system to the exemplary system 400 via the user interface 410. The user interface 410 may also be employed by the user to define a required output orientation state for an image receiving medium to be processed by the complex document handling and image forming system.

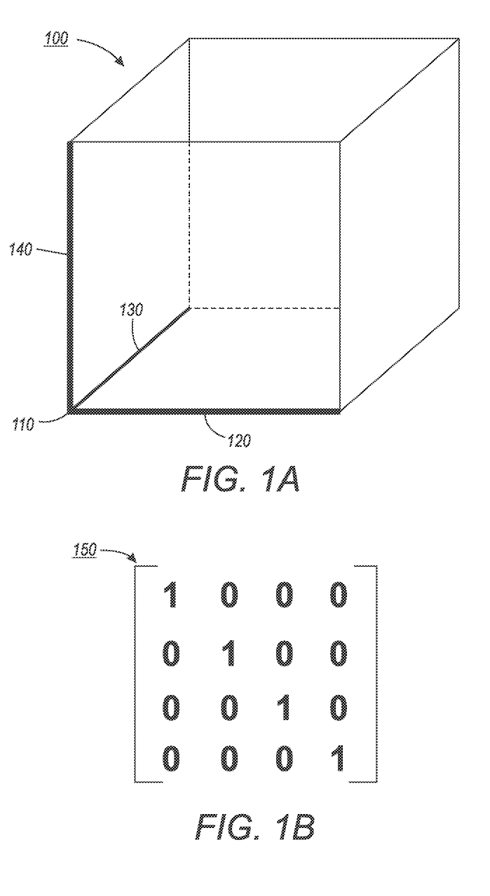

The exemplary system 400 may include a data output/display device 420 that may display information regarding user inputs provided via the user interface 410 as well as information regarding the functioning of the exemplary system 400. The data output/display device 420 may, for example, be employed to display lists of nodes and lists of note adjacencies as they are compiled by inputs from a user via the user interface 410, or are otherwise compiled by information gathered by the exemplary system 400 via, for example, communication with one or more individual component devices that comprise a complex document handling and image forming system, the information being passed to the exemplary system 400 through one or more external communication interfaces 450. The data output/display device 420 may also be employed to display simplified block diagram models of a complex document handling and image forming system such as that shown in FIG. 2, or a derived directed graph representing nodal interrelationships in a complex document handling and image forming system such as that shown in FIG. 3. Either of these depictions may aid the user in identifying all the nodes, or otherwise understanding the specific inter-node relationships that define portions of individual processing flow paths through the complex document handling an image from system. Varying orientations for image receiving media in the complex document handling an image forming system may also be displayed on the data output/display device 420, particularly, for example, a graphical depiction of a required output state that is input by a user via the user interface 410, or otherwise, and/or a required input state for the image receiving media to inform a user how the image receiving media is to be placed in an image receiving media source such as, for example, an input paper tray. When displaying such specific orthogonal orientations, it is anticipated that the data output/display device 420 may provide graphical depictions of three-dimensional coordinate systems visually in the manner shown, for example, in FIG. 1A. In this manner, a user may be easily informed regarding specific orthogonal orientations under scrutiny with no need to understand the underlying processing.

The data output/display device 420 may comprise any conventional means by which to display relevant data regarding the functioning of the exemplary system 400, and may provide the user, in conjunction with the user interface 410, a means to interactively communicate with, and control, the functions undertaken by the exemplary system 400.

The exemplary system 400 may include one or more local processors 430 for individually operating the exemplary system 400 and carrying out portions of the mapping/graphing functions of the exemplary system 400. Processor(s) 430 may include at least one conventional processor or microprocessor including, for example, a Graphical Processing Unit (GPU) or Central Processing Unit (CPU), that may be provided to interpret and execute instructions in cooperation with other system components for executing a processing scheme, based on a list of provided nodes, node adjacencies, and inter-node operations, to compute composite transforms for each processing path in a complex document handling and image forming system. The processor 420 may take inputs received via the user interface 410, received via one or more external communication interfaces 450 in communication with, for example, individual component devices that are rolled up and plugged in to comprise the complex document handling and image forming system, or otherwise that may be recovered from a digital data storage device 440 regarding system configuration, or orientation changes (transformations) associated with, for example, a particularly-listed set of component devices that may be stored in such a digital data storage device 440.

Processor(s) 430 may execute a process, given minimal inputs such as those described above, to map each of multiple processing paths in the complex document handling and image forming device. The processor(s) may then undertake the OFG processing scheme described in this disclosure autonomously, or in combination with other components specifically programmed to undertake those operations, as will be described in greater detail below.

The exemplary system 400 may include one or more data storage devices 440 to store relevant data, and/or such operating programs as may be used by the exemplary system 400, and specifically the processor(s) 430 to carry into effect the specified OFG processing scheme according to this disclosure. At least one data storage device 440 may be designated to act as a specific repository for storing a database that may be pre-loaded with mathematical representations of changes in two-dimensional or three-dimensional orthogonal orientations that occur in each of a specified list of individual component devices that may be used to construct the complex document handling and image forming system. It is these “individual device” orthogonal orientation changes that may be mathematically represented and matrix multiplied to achieve a composite mathematical transformation that defines an overall change in orthogonal orientations from one end of a processing path to another end of the processing path among the multiple processing paths available in a complex document handling and image forming system.

Data storage device(s) 440 may include a random access memory (RAM) or another type of dynamic storage device that is capable of storing collected information, and separately of storing instructions for execution of system operations by, for example, processor(s) 430. Data storage device(s) 440 may also include a read-only memory (ROM), which may include a conventional ROM device or another type of static storage device that stores static information and instructions for processor(s) 430.

The exemplary system 400 may include one or more external data communication interfaces 450. As indicated above, the external data communication interface(s) 450 may be provided to facilitate communication with one or more component devices of the complex document handling and image forming system in order to obtain information from each of those individual one or more component devices. The information obtained from the one or more component devices may include identification of the device (in order that a database including information regarding system operation for the one or more component devices may be queried) or direct information regarding system operation for the one or more component devices to include, but not be limited to, a change in orthogonal orientation of an image receiving medium as that image receiving medium passes through, and is operated on by, the one or more component devices. The external data communication interface(s) 450 may be provided to facilitate wired or wireless communication between the exemplary system 400 and the one or more component devices.

The exemplary system 400 may include an operational flow graph (OFG) processing device 460 that may be specifically linked to individual device components such as, for example, a node adjacency unit 462, a component operations orientation mapping unit 464, and a directed graph generating unit 466. The OFG processing device 460 may include its own processing components by which to execute the processing methods according to this disclosure. Specifically, the OFG processing device 460 may take inputs regarding individual nodes through a complex document handling and image forming system, and relationships therebetween, and develop its own node adjacency table specifically using the capabilities of an individual node adjacency unit 462. The OFG processing device 460 may then specify inter-nodal operations, and specifically changes in orthogonal orientations occurring according to those inter-nodal operations for each adjacent pair of nodes determined by the node adjacency unit 462 using, for example, a component operations orientation mapping unit 464. The OFG processing device 460 may direct generation and display of a directed graph as a basic map for node relationships across the multiple paths determined for a complex document handling and image forming system.

With the information regarding node adjacencies and inter-nodal operations, including mathematical representations of changes in orthogonal orientations that occur in each of the inter-nodal operations, presented as mathematical matrices, the OFG processing device may determine a set of composite transformations that represent end-to-end orthogonal orientation changes across each of multiple processing paths in the complex document handling and image forming system and represent those composite transformations as a single mathematical matrix. The OFG processing device 460 may operate autonomously or in conjunction with the processor(s) 430 and/or the one or more storage devices 440 to carry out the above-described functions. The OFG processing device 460, autonomously or in conjunction with the other devices, may also (1) apply an inverse of the mathematical representation of the computed composite transformation for a particular processing path for the complex document handling and image forming device via matrix multiplication to arrive at a required input orientation for the image receiving medium and (2) format information regarding the determine required input orientation via, for example, the data output/display device 420 to a user, e.g., as a visual representation of a required input orientation to aid the user in pre-flight configuration of the complex system.

All of the various components of the exemplary system 400, as depicted in FIG. 4, may be connected by one or more data/control busses 470. These data/control busses 470 may provide wired or wireless communication between the various components of the exemplary system 400 regardless of whether those components are housed within, for example, a single computing device, or individual ones of the components are housed independently.

It should be appreciated that, although depicted in FIG. 4 as what appears to be an integral unit, the various disclosed elements of the exemplary system 400 may be arranged in any combination of sub-systems as individual components or combinations of components, integral to a single unit, or as separate components housed in one or more user workstations or other devices, associated with one or more complex document handling an image forming systems. Therefore, no specific configuration for the exemplary system 400 is to be implied by the depiction in FIG. 4.

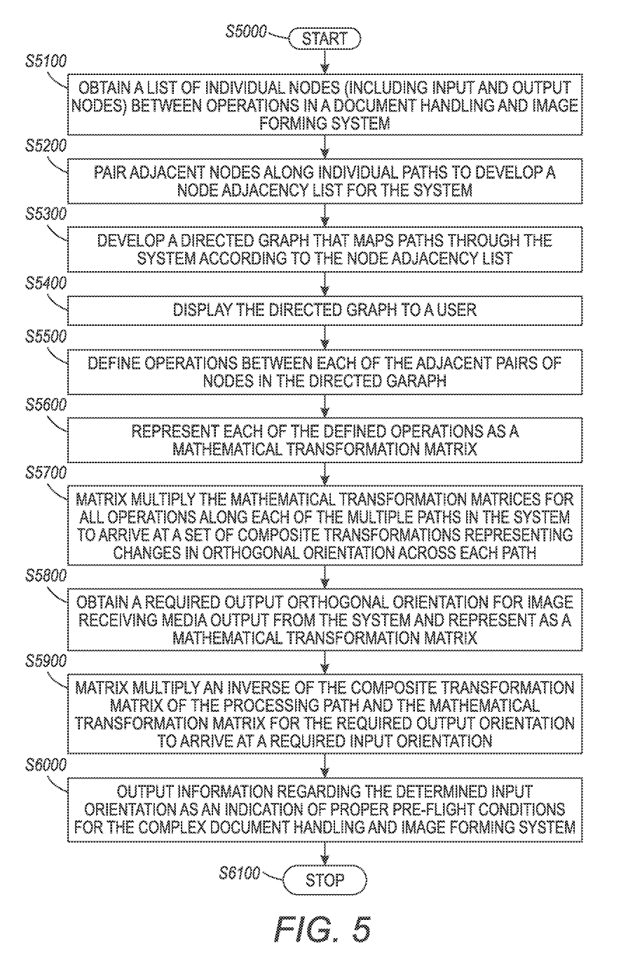

The disclosed embodiments include a method for automatically defining composite orthogonal orientation matrices for operations along multiple processing paths in complex document handling and image forming systems using orientation flow graphs in three dimensions. FIG. 5 illustrates a flowchart of such an exemplary method. As shown in FIG. 5, operation of the method commences at Step S5000 and proceeds to Step S5100.

In Step S5100, a list of individual nodes, including input and output nodes, between operations in a complex document handling and image forming system may be obtained. The list of individual nodes may be obtained, for example, via manual input by the user, or otherwise may be obtained by some automated process by which multiple paths in a complex document handling and image forming system may be decomposed. Operation of the method proceeds to Step S5200.

In Step S5200, nodes may be paired according to their individual adjacencies across specified processing paths in the document handling an image forming system. A result of this pairing is to arrive at an adjacency list for the paired nodes. Operation of the method proceeds to Step S5300.

In Step S5300, a directed graph derived from the adjacency list may be developed that graphically depicts the multiple paths between nodes through the document handling image forming system including directional arrows to provide an indication of loops (or cycles) in any particular path between nodes in the system. Operation of the method proceeds to Step S5400.

In Step S5400, the developed directed graph may be output in a form that is usable to a user in order that the user may have an indication of the paths through the document handling and image forming system. Such output made include displaying the directed graph on a digital display device, or printing the directed graph on an image receiving medium for hardcopy output. Operation of the method proceeds to Step S5500.

In Step S5500, individual operations (transformations) are defined between each of the adjacent nodes represented by the directed graph. An objective of the definition of the operations (transformations) between the adjacent nodes may be to determine and describe a change in orthogonal orientation of an image receiving medium according to the operation (transformation) that occurs between each pair of adjacent nodes. Operation of the method proceeds to Step S5600.

In Step S5600, each operation (transformation) defined in Step S5500 may be represented by a mathematical representation matrix. Each mathematical representation is intended to describe a specific three-dimensional change in orthogonal orientations of an image receiving medium as it is acted upon by the specific operation (transformation) to change the orientation of the image receiving medium from one orthogonal orientation to another orthogonal orientation relative to a specified three-dimensional coordinate system. Operation of the method proceeds to Step S5700.

In Step S5700, once all of the operations (transformations) between individual nodes along each of multiple paths in the document handling and image forming system are defined, the mathematical representations that describe those operations are matrix multiplied together for combinations of operations (transformations) along each of the multiple paths in the document handling and image forming system to arrive at a composite mathematical representation of the combination of changes in orthogonal orientations across all of the operations (transformations) in a particular path through the document handling and image forming system. Composite transformation matrices, therefore, may be defined according to each of the multiple paths through the document handling and image forming system. Operation of the method proceeds to Step S5800.

In Step S5800, a required output orthogonal orientation for an image receiving medium output from the document handling and image forming system may be obtained. The required output orthogonal orientation will be described according to a specific three-dimensional coordinate system. The required output orthogonal orientation may be obtained manually via, for example, a manual user input, or may otherwise be obtained automatically in communication with the document handling and image forming system, or, for example, may be retrieved from a stored database that includes information regarding required output orthogonal orientations for certain document handling and image forming systems. Operation of the method proceeds to Step S5900.

In Step S5900, the required output orthogonal orientation, regardless of how it is obtained, may be mathematically represented and matrix multiplied by an inverse of the composite transformation matrix for a particular path through the document handling and image forming system. A result of this matrix multiplication is a mathematical representation of a required input orthogonal orientation for image receiving media in order that, when the image receiving media is processed via the particular path for the document handling and image forming system, the required output orthogonal orientation for the image receiving media is obtained. Operation of the method proceeds to Step S6000.

In Step S6000, information regarding the determined input orientation is displayed for, or otherwise output to, a user, or for example, an upstream feeder, in order that the user, or the system, is provided with an indication of a proper pre-flight condition by which to orient image receiving media in an image receiving media source (paper tray), or at a particular node, for the document handling and image forming system. Operation of the method proceeds to Step S6100, where operation the method ceases.

The disclosed embodiments may include a non-transitory computer-readable medium storing instructions which, when executed by a processor, may cause the processor to execute all, or at least some, of the steps of the method outlined above.

The above-described exemplary systems and methods reference certain conventional components to provide a brief, general description of suitable processing and communicating means by which to carry into effect the disclosed OFG processing scheme for familiarity and ease of understanding. Although not required, elements of the disclosed exemplary embodiments may be provided, at least in part, in a form of hardware circuits, firmware, or software computer-executable instructions to carry out the specific functions described. These may include individual program modules executed by one or more processors. Generally, program modules include routine programs, objects, components, data structures, and the like that perform particular tasks, or implement particular data types, in support of the overall objective of the systems and methods according to this disclosure.

Those skilled in the art will appreciate that other embodiments of the disclosed subject matter may be practiced with many types of processing systems in many different configurations. It should be recognized that embodiments according to this disclosure may be practiced, for example, in computing systems executing differing programming languages. Embodiments according to this disclosure may be practiced in network environments, where processing and control tasks may be performed according to instructions input at a user's workstation and/or according to predetermined schemes that may be stored in data storage devices and executed by particular processors, which may or may not be in communication with, one or more component devices associated with one or more complex document handling and image forming systems.

As indicated above, embodiments within the scope of this disclosure may also include computer-readable media having stored computer-executable instructions or data structures that can be accessed, read and executed by one or more processors. Such computer-readable media can be any available media that can be accessed by a processor, general purpose or special purpose computer. By way of example, and not limitation, such computer-readable media can comprise RAM, ROM, EEPROM, CD-ROM, flash drives, data memory cards or other analog or digital data storage device that can be used to carry or store desired program elements or steps in the form of accessible computer-executable instructions or data structures. When information is transferred, or provided, over a network or via another communications connection, whether wired, wireless, or in some combination of the two, the receiving processor properly views the connection as a computer-readable medium. Combinations of the above should also be included within the scope of the computer-readable media for the purposes of this disclosure.

Computer-executable instructions include, for example, non-transitory instructions and data that can be executed and accessed respectively to cause a processor to perform certain of the above-specified functions, individually or in various combinations. Computer-executable instructions may also include program modules that are remotely stored for access and execution by a processor.

The exemplary depicted sequence of executable instructions or associated data structures represents one example of a corresponding sequence of acts for implementing the functions described in the steps. The exemplary depicted steps may be executed in any reasonable order to effect the objectives of the disclosed embodiments. No particular order to the disclosed steps of the method is necessarily implied by the depiction in FIG. 5, and the accompanying description, except where a particular method step is a necessary precondition to execution of any other method step.

Although the above description may contain specific details, they should not be construed as limiting the claims in any way. Other configurations of the described embodiments of the disclosed systems and methods are part of the scope of this disclosure.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1. A method for modeling flow paths in a document handling and image forming system, comprising:
identifying multiple flow paths for a document handling and image forming system;
specifying a plurality of individual operations that occur along each of the identified multiple flow paths;
defining each of the plurality of individual operations by mathematical representation that describes a change in an orthogonal orientation that occurs in each of the plurality of individual operations; and
determining, with a processor, an overall composite transformation matrix representing at least one of the multiple flow paths by combining the mathematical representations that describe the change in the orthogonal orientation that occurs in each of the plurality of individual operations along the at least one of the multiple flow paths; and
outputting information regarding an overall change in an orthogonal orientation along the at least one of the multiple flow paths based on the overall composite transformation matrix representing the at least one of the multiple flow paths.

2. The method of claim 1, the identifying the multiple flow paths comprising:
identifying a plurality of nodes between the plurality of individual operations along the multiple flow paths;
pairing adjacent ones of the plurality of nodes to form a node adjacency list; and
defining the multiple flow paths according to the nodes traversed by the multiple flow paths between one or more input nodes and one or more output nodes.

3. The method of claim 2, at least one of the identifying, the pairing and the defining being based on at least one user input.

4. The method of claim 2, the identifying the multiple flow paths further comprising representing the multiple flow paths as a directed graph including the plurality of nodes and directed vectors between the plurality of nodes.

5. The method of claim 4, displaying the directed graph to a user.

6. The method of claim 1, the plurality of individual operations being individual operations undertaken respectively by a plurality of component devices included in the document handling and image forming system.

7. The method of claim 6, the plurality of individual operations being specified according to information automatically received from the plurality of component devices.

8. The method of claim 7, the defining of the each of the plurality of individual operations as mathematical representations being based on stored data associated with the plurality of component devices.

9. The method of claim 1, the processor being programmed to determine the overall composite transformation matrix for the at least one of the multiple flow paths by matrix multiplying the mathematical representations that describe the change in the orthogonal orientation that occurs in each of the plurality of individual operations along the at [? the at] least one of the multiple flow paths.

10. The method of claim 1, further comprising:
identifying a required output orthogonal orientation for a sheet of image receiving media output from the document handling and image forming device;
defining the required output orthogonal orientation for the sheet of image receiving media as a mathematical representation;
applying the output information regarding the overall change in the orthogonal orientation along the at least one of the multiple flow paths to the required output orthogonal orientation to determine a required input orthogonal orientation for the image receiving medium; and
outputting information regarding the required input orthogonal orientation for the image receiving medium.

11. The method of claim 10, the applying the output information comprising matrix multiplying the mathematical representation that defines the required output orthogonal orientation by an inverse of the overall composite transformation matrix representing the at least one of the multiple flow paths to determine a mathematical representation that defines the required input orthogonal orientation.

12. The method of claim 11, further comprising:
converting the mathematical representation that defines the required input orthogonal orientation to a graphical display; and
displaying the graphical display to a user on a display device.

13. A system for modeling flow paths in a document handling and image forming system, comprising:
a user input device by which a user manually identifies multiple flow paths for a document handling and image forming system;
a processor that is programmed to
specify a plurality of individual operations that occur along each of the identified multiple flow paths;
define each of the plurality of individual operations as mathematical representations that describe a change in an orthogonal orientation that occurs in each of the plurality of individual operations; and
determine an overall composite transformation matrix representing at least one of the multiple flow paths by combining the mathematical representations that describe the change in the orthogonal orientation that occurs in each of the plurality of individual operations along the at least one of the multiple flow paths; and
an output device that outputs information regarding an overall change in an orthogonal orientation along the at least one of the multiple flow paths based on the overall composite transformation matrix representing the at least one of the multiple flow paths.

14. The system of claim 13, the user manually identifying the multiple flow paths by:
inputting a plurality of nodes between the plurality of individual operations along the multiple flow paths; and
identifying paired adjacent ones of the plurality of nodes to form a node adjacency list,
the processor being further programmed to define the multiple flow paths according to the nodes traversed by the multiple flow paths between one or more input nodes and one or more output nodes.

15. The system of claim 13, the processor being further programmed to
represent the multiple flow paths as a directed graph including the plurality of nodes and directed vectors between the plurality of nodes, and
display the directed graph on a display device.

16. The system of claim 13, further comprising at least one external communication interface for obtaining information regarding individual operations undertaken respectively by a plurality of component devices included in the document handling and image forming system,
the plurality of individual operations being specified according to information automatically received from the plurality of component devices via the at least one external communication interface.

17. The system of claim 16, further comprising at least one data storage device storing data associated with the plurality of component devices by which to define the mathematical representations that describe the change in the orthogonal orientation that occurs in each of the plurality of individual operations carried out by each of the plurality of component devices.

18. The system of claim 13, the processor being further programmed to determine the overall composite transformation matrix for the at least one of the multiple flow paths by matrix multiplying the mathematical representations that describe the change in the orthogonal orientation that occurs in each of the plurality of individual operations along the at least one of the multiple flow paths.

19. The system of claim 13, the processor being further programmed to:
obtain information identifying a required output orthogonal orientation for a sheet of image receiving media output from the document handling and image forming device;
define the required output orthogonal orientation for the sheet of image receiving media as a mathematical representation;
apply the output information regarding the overall change in the orthogonal orientation along the at least one of the multiple flow paths to the required output orthogonal orientation to determine a required input orthogonal orientation for the image receiving medium; and
output information on the required input orthogonal orientation for the image receiving medium,
the output information on the required input orthogonal orientation being obtained by matrix multiplying the mathematical representation that defines the required output orthogonal orientation by an inverse of the overall composite transformation matrix representing the at least one of the multiple flow paths to determine a mathematical representation that defines the required input orthogonal orientation.

20. A non-transitory computer-readable medium storing instructions which, when executed by a processor, cause the processor to execute the steps of a method comprising:
identifying multiple flow paths for a document handling and image forming system;
specifying a plurality of individual operations that occur along each of the identified multiple flow paths;
defining each of the plurality of individual operations as mathematical representations that describe a change in an orthogonal orientation that occurs in each of the plurality of individual operations; and
determining an overall composite transformation matrix for at least one of the multiple flow paths by combining the mathematical representations that describe the change in the orthogonal orientation that occurs in each of the plurality of individual operations along the at least one of the multiple flow paths; and
outputting information regarding an overall change in an orthogonal orientation along the at least one of the multiple flow paths based on the overall composite transform representing the at least one of the multiple flow paths.
